(19) United States
(12) Patent Application Publication
(10) Pub. No.: US 2022/0138750 A1
(43) Pub. Date: May 5, 2022

(54) SECURING TRANSACTIONS VIA MULTI-DEVICE AUTHENTICATION

(71) Applicant: Shtar LLC, Brooklyn, NY (US)

(72) Inventor: Moshe B. Teitelbaum, Brooklyn, NY (US)

(21) Appl. No.: 17/425,310

(22) PCT Filed: Jan. 22, 2020
(86) PCT No.: PCT/US2020/014676

§ 371 Date: Jul. 22, 2021

Related U.S. Application Data
(60) Provisional application No. 62/795,127, filed on Jan. 22, 2019.

(51) Int. Cl. G06Q 20/40

(52) U.S. Cl. CPC G06Q 20/4014; G06Q 20/405

(57) ABSTRACT

Systems and methods are disclosed for securing transactions via multi-device authentication. In one implementation, a transaction initiation request is received. The transaction initiation request is processed to generate a first transaction segment and a second transaction segment. A first authentication input is received, via a first device, with respect to the first transaction segment. In The first authentication input is validated. A second authentication input is received via a second device with respect to the second transaction segment. The second authentication input is validated. Based on a validation of the first authentication input with respect to the first transaction segment and a validation of the second authentication input with respect to the second transaction segment, execution of a transaction corresponding to the transaction initiation request is initiated.

### CROSS-REFERENCE TO RELATED APPLICATION

This application is related to and claims the benefit of U.S. Patent Application No. 62/795,127, filed Jan. 22, 2019, which is incorporated herein by reference in its entirety.

### TECHNICAL FIELD

Aspects and implementations of the present disclosure relate to data processing and, more specifically, but without limitation, to securing transactions via multi-device authentication.

### BACKGROUND

Transactions and other operations can be authenticated via various authentication techniques. The authentication of such transactions, operations, etc., can be advantageous in numerous technical contexts.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 is a flow chart illustrating a method, in accordance with example embodiments, for securing transactions via multi-device authentication.

FIG. 3 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to securing transactions via multi-device authentication.

Existing technologies enable users to authenticate or verify their identities via various authentication techniques. However, various security vulnerabilities remain. For example, verification based on a single input may be susceptible to hacking, tampering, or other fraudulent use. Such unauthorized activities can cause significant damage, loss, and other vulnerabilities in numerous contexts.

Accordingly, described herein in various implementations are technologies, including systems, methods, and machine-readable mediums, that enable multi-device authentication. Using the described technologies, a single transaction, operation, etc. can be authenticated via multiple devices (e.g., using multiple authentication techniques) prior to execution. In doing so, the security of such a transaction can be enhanced and the functioning of various particular machine(s)/system(s) can be improved, as described in detail herein.

It can therefore be appreciated that the described technologies are directed to and address specific technical challenges and longstanding deficiencies in multiple technical areas, including but not limited to user authentication, cybersecurity, and secure transactions. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

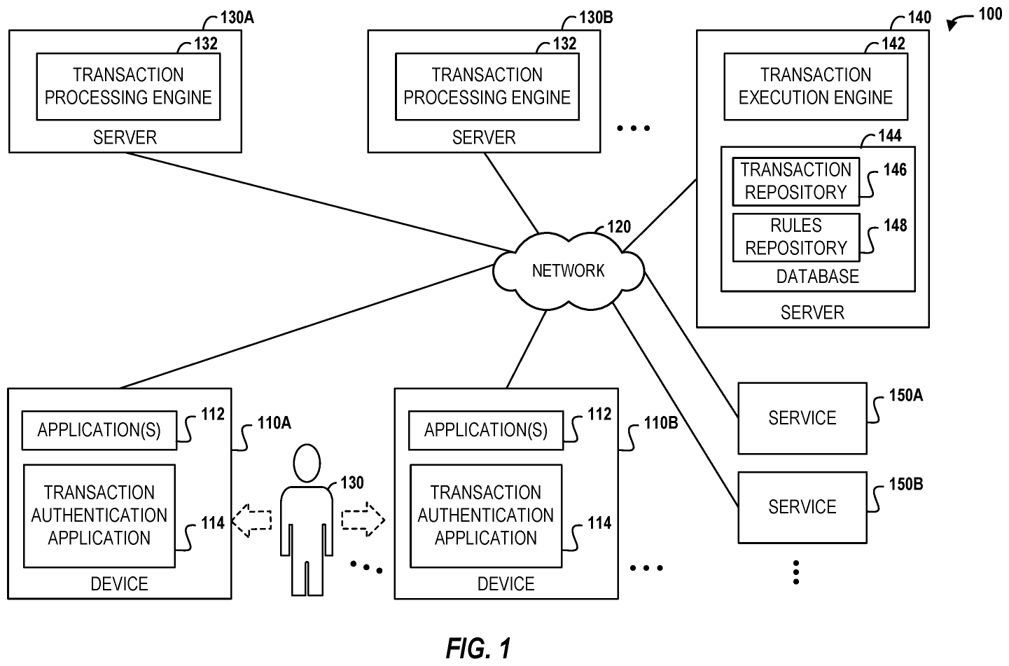

FIG. 1 illustrates an example system 100, in accordance with some implementations. As shown, the system 100 includes components such as device 110A and device 110B (collectively, devices 110). Each of the referenced devices 110 can be, for example, a laptop computer, a desktop computer, a terminal, a mobile phone, a tablet computer, a smart watch, a wearable device, a personal digital assistant (PDA), a digital music player, a connected device, a speaker device, a server, and the like. User 130 can be a human user who interacts with device(s) 110. For example, user 130 can provide various inputs (e.g., via an input device/interface such as a keyboard, mouse, touchscreen, microphone, etc.) to device(s) 110. Device(s) 110 can also display, project, and/or otherwise provide content to user 130 (e.g., via output components such as a screen, speaker, etc.).

As shown in FIG. 1, device(s) 110 can include one or more application(s) 112. Such applications can be programs, modules, or other executable instructions that configure/enable the device to interact with, provide content to, and/or otherwise perform operations on behalf of user 130. Examples of such applications include but are not limited to: internet browsers, mobile apps, ecommerce applications, social media applications, personal assistant applications, games, etc. By way of further illustration, application(s) 112 can include mobile apps that enable users to initiate various transactions with third party services 150, such as banking services, food delivery services, ride sharing services, ecommerce services, etc.

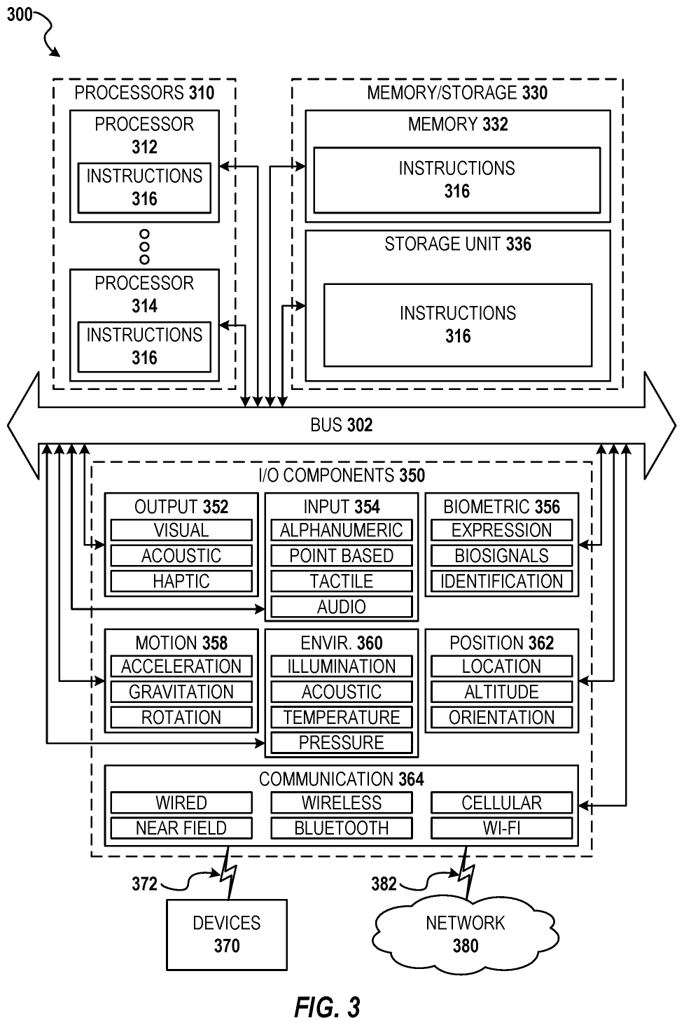

Application(s) 112 can be stored in memory of device 110 (e.g. memory 330 as depicted in FIG. 3 and described below). One or more processor(s) of device 110 (e.g., processors 310 as depicted in FIG. 3 and described below) can execute such application(s). In doing so, device 110 can be configured to perform various operations, present content to user 130, etc.

In certain implementations, device 110 can also include transaction authentication application 114. Transaction authentication application 114 can be, for example, a program, module, or other executable instruction(s) that configures/enables the device to perform one or more operations. In certain implementations, transaction authentication application 114 can configure device 110 to prompt a user to provide one or more inputs (e.g., authentication inputs), process and/or validate such inputs, and/or transmit or otherwise provide such received inputs to other machines (e.g., servers 130A-130B, as described herein).

For example, as described herein, user 130 can provide one or more authentication inputs via device 110A. Such authentication inputs can be, for example, information that can be used to verify or determine the identity of user 130. By way of illustration, user 130 can provide a password, biometric identifier (e.g., fingerprint, retina scan, etc.), or other such input(s) via device 110A. In certain implementations, such authentication inputs can be provided in relation to a transaction or other such operation initiated by the user 130 (e.g., a business/financial transaction, ecommerce purchase, technical operation, etc.).

It should be noted that while application(s) 112 and 114 are depicted and/or described as executing on a device 110, this is only for the sake of clarity. However, in other implementations such elements can also be implemented on other devices/machines. For example, in lieu of executing locally at device 110, aspects of application(s) 112 can be implemented remotely (e.g., on a server device or within a cloud service or framework).

As also shown in FIG. 1, device 110 can connect to and/or otherwise communicate with servers 130A, 130B, and 140, and services 150 via network 120. Network 120 can include one or more networks such as the Internet, a wide area network (WAN), a local area network (LAN), a virtual private network (VPN), an intranet, and the like.

Service 150A and service 150B (collectively, services 150) can be for example, third-party services that enable users to initiate various operations and/or transactions. Examples of operations/transactions enabled by services 150 include but are not limited to financial/business transactions, purchasing goods for shipment, placing restaurant/food orders for delivery, requesting taxi dispatch, and/or any other such. In certain implementations, user 130 can initiate a transaction with such a service via an application (e.g., a web browser or dedicated mobile application) executing on device 110.

Server 130A and server 130B (collectively, servers 130) can be, for example, server computers, computing devices, storage services (e.g., a ‘cloud’ service), etc. In certain implementations, server(s)/services(s) 130 can be configured to enable users to authenticate their identities. Such authentication operation(s) can be advantageous in numerous scenarios. For example, it can be advantageous for a user initiating a transaction, operation, etc. to verify his/her identity in order to complete various secure transactions.

In certain implementations, each of servers 130 can include transaction processing engine 132. Transaction processing engine 132 can be an application, module, instructions, etc., that configures/enables the server/service 130 to authenticate an identity of a user. As noted, in certain implementations such authentication operation(s) can be performed in connection with a transaction (and/or a portion thereof), as described herein.

Moreover, in certain implementations, the described technologies can be configured to authenticate an identity of such a user via multiple devices. In one example scenario, user 130 can initiate a transaction (e.g., a financial transaction or other such operation) via device 110A. Prior to executing the transaction, the described technologies can be configured to require the user to authenticate his/her identity multiple times at multiple devices. Accordingly, in certain implementations the user can authenticate his/her identity with respect to the referenced transaction via device 110A, and subsequently or independently authenticate his/her identity via device 110B. Doing so can authenticate the identity of the user with a greater degree of certainty (e.g., as compared to other forms of authentication), thereby enhancing the security of such operations, transactions, etc. and ensuring their legitimacy prior to and/or in connection with execution of the operation/transaction.

It should be understood that, in certain implementations, the referenced transaction can be divided into multiple segments. For example, one portion or aspect of the referenced transaction can be authenticated with respect to device 110A, while another portion of the transaction can be authenticated with respect to device 110B. Doing so can increase the security and reliability associated with the referenced transaction by increasing the likelihood that the user (who has verified the transaction, e.g., on multiple devices) is likely to be authorized to execute it.

Additionally, in certain implementations the referenced devices 110A, 110B can be further configured to authenticate transactions (and/or portions thereof) with respect to specific server(s). For example, in one implementation device 110A can authenticate one segment of a transaction with respect to server 130A while device 110B can authenticate another segment of the referenced transaction with respect to server 130B. By way of further illustration, transaction authentication application 114 as executing on device 110A can be configured to authenticate the referenced transaction with respect to a URL (or other such network address) that corresponds to server 130A, while transaction authentication application 114 as executing on device 110B can be configured to authenticate the referenced transaction with respect to a URL (or other such network address) that corresponds to server 130B. In doing so, the security of the described transaction can be enhanced, e.g., by authenticating the transaction multiple times via multiple devices in relation to multiple servers prior to executing the transaction.

Having authenticated multiple segments of a transaction (e.g., via devices 110A, 110B in relation to servers 130A, 130B), the respective authenticated segments can be provided or otherwise made accessible to server 140.

Server 140 can be, for example, a server computer, computing device, storage service (e.g., a ‘cloud’ service), etc. that enable enables the execution of secure transactions, as described herein. In certain implementations, server 140 can include transaction execution engine 142.

Transaction execution engine 142 can be an application, module, set of instructions, etc. that configures/enables server 140 to perform various operations described herein. In certain implementations, transaction execution engine 142 can authenticate multiple segments of a transaction (e.g., as received from devices 110 and/or servers 130). In other implementations, transaction execution engine 142 can aggregate authentications/validations performed at other devices/services (e.g., at servers 130A and 130B), and complete execution of a transaction based on such aggregation, as described herein. These and other described features, as implemented with respect to server 140 and/or one or more particular machine(s), can improve the functioning of such machine(s) and/or otherwise enhance numerous technologies including enabling the security, execution, and management of various transaction(s), as described herein.

In certain implementations, server 140 can also include database 144. Database 144 can be a storage resource such as an object-oriented database, a relational database, a decentralized or distributed ledger (e.g., blockchain), etc. In certain implementations, various repositories such as transaction repository 146 and rules repository 148 can be defined and stored within database 144.

Transaction repository 146 can be, for example, a ledger of various transactions (e.g., financial transactions or other operations) between various users, accounts, entities, etc. Such a ledger can reflect, for example, information corresponding to such transactions, including but not limited to data identifying the user/entity, a transaction amount, a timestamp, etc.

Rules repository 148 can be, for example, a storage resource that maintains records of various rules, as described herein. In certain implementations, such rules can define various parameters or conditions that define the manner in which the described authentication operation(s) are to be implemented with respect to certain transactions. For example, in certain implementations a user or administrator can define various conditions that can result in a transaction being authenticated in different ways under different circumstances.

By way of illustration, an example rule can define different types of authentication based on the identity of a vendor with respect to which a transaction/operation is initiated. For example, a user or administrator can define a rule whereby payments directed to ‘Vendor ABC’ (e.g., a trusted vendor) may require only a single authentication/validation instance, while payments to other vendors (or to a specific untrusted vendor) may require additional authentication/validation instances.

In another example, a user/administrator can define rule(s) pertaining to transaction amounts/thresholds. For example, different types/amounts of authentication/validation instance(s) may be required depending on whether a transaction is above or below a defined threshold (e.g. $500 or less).

In yet other examples, aspects of the described authentication/validation can change based on the timing/frequency of certain transactions. For example, certain transactions (e.g., utility payments) may be authenticated in one way when initiated once per month. However, if/when initiated more frequently, such transactions may require additional authentication(s).

In other example scenarios, the referenced rules/parameters can dictate that different types, quantities, and/or combinations of various authentication techniques may be required for certain transactions based on to inputs or determinations originating from various sensors and/or other devices. For example, as described herein, rules, conditions, etc., can be defined with respect to a location (e.g., geographic coordinates corresponding to the current location of a user attempting to authenticate a transaction). By way of illustration, such conditions can dictate that a single authentication instance is required to authenticate a transaction when such authentication originates from a device within a defined proximity (e.g., 10 miles) of a home address of a user. Such a determination can be computed, for example, based on input(s) originating from a GPS receiver of a device associated with such a user. In other scenarios, such as when such authentication originates from a device located beyond a defined proximity (e.g., over 100 miles away from) a home address of a user, additional authentication instances (e.g., three authentication instances) may be required in order to authenticate such a transaction. In doing so, the described technologies can enhance the security of associated transactions in scenarios in which such enhanced security is determined to be most likely to be relevant.

In these and other implementations and scenarios, the described technologies can further configure and/or otherwise interact with various sensor(s) to enhance and/or improve the functioning of one or more machine(s). Doing so can enhances the security, execution, and management of various transactions, as described herein. In contrast, existing technologies are incapable of enabling performance of the described operations in a manner that ensures their efficient execution and management, while also maintaining the security and integrity of such transactions, as described herein.

It should be understood that the examples provided herein are intended only for purposes of illustration and any number of other implementations are also contemplated. Additionally, the referenced examples (including the described rules) can be combined in any number of ways. For example, rules/conditions pertaining to a vendor identity, a transaction amount, and a user location, can be combined and utilized with respect to a single transaction. In doing so, the described technologies can enhance and/or improve the functioning of one or more machine(s) and/or increase the security of various transactions, e.g., by ensuring defined rules and conditions are met and the identity of the user is sufficiently authenticated/validated prior to executing or completing a transaction.

These and other described features, as implemented with respect to one or more particular machine(s) described herein, can improve the functioning of such machine(s) and/or otherwise enhance numerous technologies including enabling the security, execution, and management of various transactions, as described herein.

By way of illustration, upon receiving confirmation from server 130A and 130B that a transaction, operation, etc. initiated by user 130 has been authenticated via multiple devices, server 140 can complete execution of the referenced transaction (e.g., via transaction execution engine 142). In certain implementations, execution of such a transaction/operation may entail providing commands, confirmations, approvals, etc., to various services 150 (e.g., in connection with ecommerce purchases or other services).

Additionally, in certain implementations various aspects of the described technologies can be defined with respect to certain types of transactions/operations. For example, as described above, one or more rules, parameters, etc., can configured the described technologies such that transactions associated with a defined monetary amount, type of purchase, etc. can may require a certain degree of authentication (e.g., authentication via two devices) while other types of transactions may require authentication via additional devices.

Moreover, in certain implementations various aspects of one authentication instance can dictate or direct further aspects of subsequent authentication instance(s). For example, in a scenario in which a user authenticates via an IP address determined to be relatively proximate to an address (e.g., a home address) associated with the user, the described technologies may be configured to require only one additional authentication (e.g., via an additional device). In contrast, in scenarios in which a user authenticates via an IP address determined to be relatively distant from such an address associated with the user (e.g., in another country), the described technologies may be configured to require additional authentication instances (e.g., via two or more additional devices). In doing so, the described technologies can account for the circumstances and context within which a transaction/operation (and the associated authentication instances) are being performed, thereby enhancing the security of such a transaction in a manner most efficient for the user(s). In contrast, existing technologies may not require the described authentication/verifications(s) and may thus be less secure, or may require multiple verifications under all circumstances (resulting in considerable inefficiencies).

In another example, the described technologies may, under certain circumstances (e.g., transactions above a certain threshold, transactions involving foreign vendors, etc.) require certain types of authentication (e.g., biometric authentication) that may be more secure. In doing so, the described technologies can be configured to further secure certain transactions in scenarios determined to require additional levels of security.

While many of the examples described herein are illustrated with respect to multiple servers 130A, 130B, 140, this is simply for the sake of clarity and brevity. However, it should be understood that the described technologies can also be implemented (in any number of configurations) with respect to a single computing device/service.

Additionally, in certain implementations various aspects of the operations described herein with respect to multiple devices (e.g., 110A, 110B) can be implemented with respect to a single device (e.g., device 110A). For example, in certain scenarios the described technologies can be configured to perform the described authentication operations using a single device in relation to multiple servers (130A, 130B). By way of illustration, user 130 can utilize device 110A to initiate a transaction and/or authenticate a segment or aspect of such a transaction in relation to server 130A. Using the same device (110A), the user can authenticate another segment or aspect of the referenced transaction in relation to another server (130B), e.g., via a different URL/network address, etc. In doing so, the user may be required to login more than once (e.g., via different web browsers, applications, etc.), and/or otherwise provide multiple identifiers in order to authenticate/verify his/her identity and/or other aspects of the referenced transaction. In other implementations, the user may be required to perform one or more of the described authentication processes via different applications, web browsers, etc. (e.g., even in relation to a single server 140, URL/network address, etc.). In doing so, the described technologies can further enhance the security and reliability of the referenced transactions, operations, etc., even using a single device.

Additionally, as noted, various aspects of the described operations can be adjusted or configured based on determination(s) computed with respect to previous authentication instances. For example, previous authentication patterns can be identified (e.g., with respect to a particular user, transaction type, etc.), and such patterns can be accounted for in determining aspects of the authentication to be required with respect to subsequent transactions.

It can be appreciated that the described technologies provide numerous technical advantages and improvements over existing technologies. For example, the described technologies enable users to secure transactions in scenarios in which such transactions may otherwise be fraudulently executed.

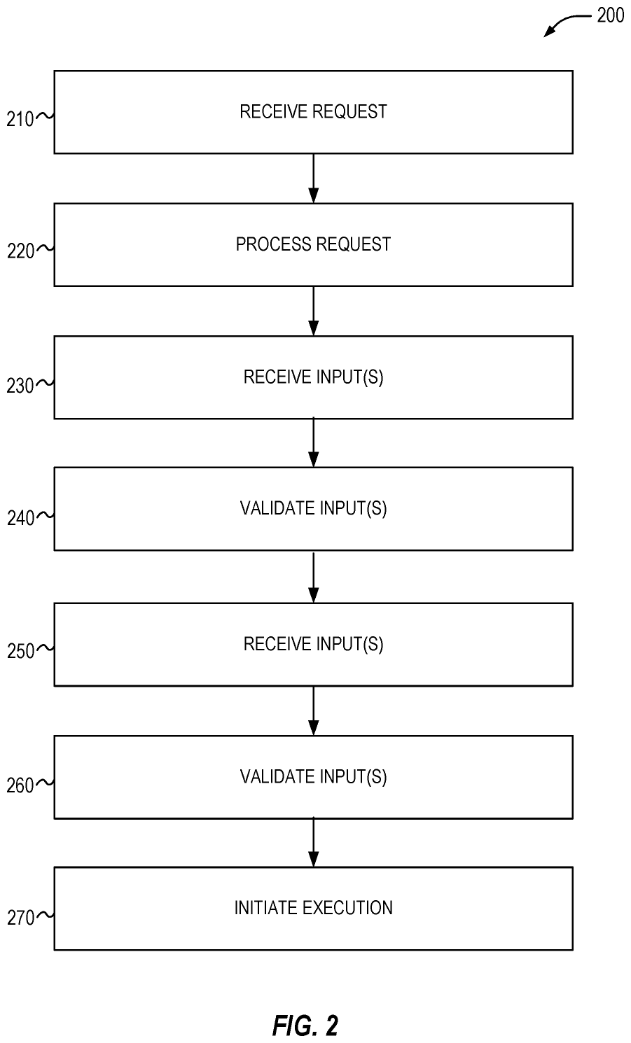

Further aspects and features of servers 130A, 130B, and 140 and device(s) 110 and are described in more detail in conjunction with FIGS. 2-3, below.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

FIG. 2 is a flow chart illustrating a method 200, according to an example embodiment, for securing transactions via multi-device authentication. The method is performed by processing logic that can comprise hardware (circuitry, dedicated logic, etc.), software (such as is run on a computing device such as those described herein), or a combination of both. In one implementation, the method 200 is performed by one or more elements depicted and/or described in relation to FIG. 1 (including but not limited to servers 130A, 130B, and/or 140, and/or device(s) 110), while in some other implementations, the one or more blocks of FIG. 2 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 210, a transaction initiation request is received. For example, as shown in FIG. 1, user 130 can generate a transaction/operation initiation request (e.g., via device 110A). Such a transaction initiation request can reflect, for example, a request to transmit payment to a particular vendor, service, etc., as described herein. In certain implementations, such a transaction initiation request can be generated by one or more programs, modules, or other executable instructions that configure/enable the device to track incoming and outgoing payments, transactions, invoices, etc. For example, the referenced user can utilize an accounting application or service configured to initiate payments, enter invoice(s), and track transactions, etc.

It should be understood that in certain scenarios the user that generates the referenced transaction initiation request may also perform one or more authentication(s) described herein. As noted, such authentication(s) can verify the identity of the user via various authentication techniques (e.g., passwords, biometric inputs, etc.). In other implementations, one user may generate the transaction initiation request, while other user(s) (e.g., administrators or other authorized parties) provide various authentication(s), e.g., in connection with review and approval of the referenced transaction.

At operation 220, the transaction initiation request (e.g., as received at 210) is processed. In doing so, one or more transaction segment(s) can be generated (e.g., a first transaction segment, second transaction segment, etc.). Such transaction segments can include or reflect representations of a portion of the requested transaction. In various scenarios authentications may need to be received with respect to some, most, or all of the referenced transaction segments in order for the transaction to be approved/executed.

In certain implementations, the referenced transaction initiation request can be processed based on/with respect to one or more rules (e.g., as stored in rules repository 148). As described herein, such rules can include but are not limited to: entity restriction(s) (e.g., which define the manner of authentication necessary with respect to a transaction directed to a certain entity), transaction amount restriction(s) (e.g., which define the manner of authentication necessary with respect to a transaction of a certain amount), transaction frequency restriction(s) (e.g., which define the manner of authentication necessary with respect to a transaction occurring at a certain frequency), and geographic restriction(s) (e.g., which define the manner of authentication necessary with respect to a transaction initiated or authenticated at a certain distance from a defined location such as the home of a user).

Moreover, in certain implementations the referenced transaction initiation request can be processed based on or more other transactions (e.g., as stored in transaction repository 146). For example, as described herein, in certain implementations the transaction history of the user that initiated a transaction request and/or of other user(s) can be accounted for in determining the manner in which such a transaction is to be authenticated. For example, in scenarios in which such transaction historie(s) reflect that transactions bearing certain characteristics are frequently approved by a user, the manner of authentication required can be adjusted accordingly (e.g., to require fewer authentication instances, less rigid forms of authentication, etc.). By way of further example, in scenarios in which such transaction historie(s) reflect that transactions bearing certain characteristics are frequently rejected or disputed, the manner of authentication required can be adjusted accordingly (e.g., to require more authentication instances, more rigid forms of authentication, etc.).

At operation 230, a first authentication input is received. Such an authentication input can be, for example, a password, biometric identifier, secret, key, etc. through which the identity of the user can be verified. In certain implementations, such authentication input(s) can be received with respect to the first transaction segment (e.g., as generated at 220). In certain implementations, such an authentication input can be provided by/received via a first device (e.g., device 110A, as shown in FIG. 1). Additionally, in certain implementations such an authentication input can be provided/received via a first network address (e.g., a URL, that corresponds to server 130A). As noted, doing so can enable authentication of various segments of the transaction via different network addresses, thereby enhancing the security of the described transaction authentication.

At operation 240, the first authentication input (e.g., as received at 230) can be validated. In certain implementations, such validation can be performed at server 130A.

In certain implementations, the referenced authentication input can be validated with respect to the first user (e.g., the user that initiated the transaction). In other implementations, the referenced authentication input can be validated the with respect to a second user (e.g., an administrator tasked with approval of transaction initiated by other users.

At operation 250, a second authentication input is received. Such an authentication input can be, for example, a password, biometric identifier, secret, key, etc. through which the identity of the user can be verified.

In certain implementations, such an authentication input can be received with respect to the second transaction segment (e.g., as generated at 220). In certain implementations, such an authentication can be received via a second device (e.g., device 110B, as shown in FIG. 1). Additionally, in certain implementations such an authentication input can be provided/received via a second network address (e.g., a URL, that corresponds to server 130B). As noted, doing so can enable authentication of various segments of the transaction via difference network addresses, thereby enhancing the security of the described transaction authentication.

Moreover, in certain implementations the referenced second authentication input can be provided/received in response to an authentication prompt generated based on the first authentication input. For example, in various scenarios, input(s) and/or other data received with respect to a transaction and/or a first authentication instance can impact the manner in which further aspects or segments of the transaction request are authenticated. For example, based on a determined location of an authenticating user that provided the first authentication input (e.g., at 240), the described technologies can be configured to prompt one or more other users to provide additional authentication. By way of illustration, in a scenario in which a first authentication input originates from another country, the described technologies can be configured to prompt/request additional authentication (e.g., by another associated user) prior to initiating execution of the corresponding transaction, operation, etc.

Moreover, in certain implementations further authentication input(s) (e.g., third, etc. authentication inputs) can be received, e.g., in response to an authentication prompt generated based on the first and/or second authentication input. For example, as noted, in certain scenarios the location from which such inputs originate and/or other factors (e.g., a transaction above a defined threshold amount) can dictate that additional authentication/verification operations be performed (e.g., by another associated user) prior to initiating execution of the corresponding transaction.

At operation 260, the second authentication input(s) are validated. In certain implementations, such validation can be performed at server 130B.

In certain implementations, the referenced authentication input can be validated with respect to the first user (e.g., the user that initiated the transaction). In other implementations, the referenced authentication input can be validated the with respect to a second user (e.g., an administrator tasked with approval of transaction initiated by other users.

At operation 270, execution of a transaction/operation corresponding to the transaction initiation request is initiated. In certain implementations, execution of such a transaction can be initiated based on the validation of the first authentication input (e.g., with respect to the first transaction segment) and the second authentication input (e.g., with respect to the second transaction segment) (e.g., at 220, 230).

Moreover, in certain implementations the referenced transaction can be initiated based on the validation of some, most, or all of the referenced authentication inputs (e.g., in scenarios in which multiple inputs are provided, whether by one or several users, as described in detail herein).

It should also be noted that while the technologies described herein are illustrated primarily with respect to user authentication and secure transactions, the described technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-2 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 3 is a block diagram illustrating components of a machine 300, according to some example implementations, able to read instructions from a machine-readable medium (e.g., a machine-readable storage medium) and perform any one or more of the methodologies discussed herein. Specifically, FIG. 3 shows a diagrammatic representation of the machine 300 in the example form of a computer system, within which instructions 316 (e.g., software, a program, an application, an applet, an app, or other executable code) for causing the machine 300 to perform any one or more of the methodologies discussed herein can be executed. The instructions 316 transform the non-programmed machine into a particular machine programmed to carry out the described and illustrated functions in the manner described. In alternative implementations, the machine 300 operates as a standalone device or can be coupled (e.g., networked) to other machines. In a networked deployment, the machine 300 can operate in the capacity of a server machine or a client machine in a server-client network environment, or as a peer machine in a peer-to-peer (or distributed) network environment. The machine 300 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 316, sequentially or otherwise, that specify actions to be taken by the machine 300. Further, while only a single machine 300 is illustrated, the term “machine” shall also be taken to include a collection of machines 300 that individually or jointly execute the instructions 316 to perform any one or more of the methodologies discussed herein.

The machine 300 can include processors 310, memory/storage 330, and I/O components 350, which can be configured to communicate with each other such as via a bus 302. In an example implementation, the processors 310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 312 and a processor 314 that can execute the instructions 316. The term “processor” is intended to include multi-core processors that can comprise two or more independent processors (sometimes referred to as “cores”) that can execute instructions contemporaneously. Although FIG. 3 shows multiple processors 310, the machine 300 can include a single processor with a single core, a single processor with multiple cores (e.g., a multi-core processor), multiple processors with a single core, multiple processors with multiples cores, or any combination thereof

The memory/storage 330 can include a memory 332, such as a main memory, or other memory storage, and a storage unit 336, both accessible to the processors 310 such as via the bus 302. The storage unit 336 and memory 332 store the instructions 316 embodying any one or more of the methodologies or functions described herein. The instructions 316 can also reside, completely or partially, within the memory 332, within the storage unit 336, within at least one of the processors 310 (e.g., within the processor's cache memory), or any suitable combination thereof, during execution thereof by the machine 300. Accordingly, the memory 332, the storage unit 336, and the memory of the processors 310 are examples of machine-readable media.

As used herein, “machine-readable medium” means a device able to store instructions (e.g., instructions 316) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 316. The term “machine-readable medium” shall also be taken to include any medium, or combination of multiple media, that is capable of storing instructions (e.g., instructions 316) for execution by a machine (e.g., machine 300), such that the instructions, when executed by one or more processors of the machine (e.g., processors 310), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 350 can include a wide variety of components to receive input, provide output, produce output, transmit information, exchange information, capture measurements, and so on. The specific I/O components 350 that are included in a particular machine will depend on the type of machine. For example, portable machines such as mobile phones will likely include a touch input device or other such input mechanisms, while a headless server machine will likely not include such a touch input device. It will be appreciated that the I/O components 350 can include many other components that are not shown in FIG. 3. The I/O components 350 are grouped according to functionality merely for simplifying the following discussion and the grouping is in no way limiting. In various example implementations, the I/O components 350 can include output components 352 and input components 354. The output components 352 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 354 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 350 can include biometric components 356, motion components 358, environmental components 360, or position components 362, among a wide array of other components. For example, the biometric components 356 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 358 can include acceleration sensor components (e.g., accelerometer), gravitation sensor components, rotation sensor components (e.g., gyroscope), and so forth. The environmental components 360 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 362 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 350 can include communication components 364 operable to couple the machine 300 to a network 380 or devices 370 via a coupling 382 and a coupling 372, respectively. For example, the communication components 364 can include a network interface component or other suitable device to interface with the network 380. In further examples, the communication components 364 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 370 can be another machine or any of a wide variety of peripheral devices (e.g., a peripheral device coupled via a USB).

Moreover, the communication components 364 can detect identifiers or include components operable to detect identifiers. For example, the communication components 364 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 364, such as location via Internet Protocol (IP) geolocation, location via Wi-Fi® signal triangulation, location via detecting an NFC beacon signal that can indicate a particular location, and so forth.

In various example implementations, one or more portions of the network 380 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 380 or a portion of the network 380 can include a wireless or cellular network and the coupling 382 can be a Code Division Multiple Access (CDMA) connection, a Global System for Mobile communications (GSM) connection, or another type of cellular or wireless coupling. In this example, the coupling 382 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 316 can be transmitted or received over the network 380 using a transmission medium via a network interface device (e.g., a network interface component included in the communication components 364) and utilizing any one of a number of well-known transfer protocols (e.g., HTTP). Similarly, the instructions 316 can be transmitted or received using a transmission medium via the coupling 372 (e.g., a peer-to-peer coupling) to the devices 370. The term “transmission medium” shall be taken to include any intangible medium that is capable of storing, encoding, or carrying the instructions 316 for execution by the machine 300, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving a transaction initiation request;
processing the transaction initiation request to generate a first transaction segment and a second transaction segment;
receiving, via a first device, a first authentication input with respect to the first transaction segment;
validating the first authentication input;
receiving, via a second device, a second authentication input with respect to the second transaction segment;
validating the second authentication input; and
based on a validation of the first authentication input with respect to the first transaction segment and a validation of the second authentication input with respect to the second transaction segment, initiating execution of a transaction corresponding to the transaction initiation request.

2. The system of claim 1, wherein receiving the first authentication input comprises receiving the first authentication input via a first network address and wherein receiving the second authentication input comprises receiving the second authentication input via a second network address.

3. The system of claim 1, wherein validating the first authentication input comprises validating the first authentication input at a first server and wherein validating the second authentication input comprises validating the second authentication input at a second server.

4. The system of claim 1, wherein receiving the second authentication input comprises receiving the second authentication input in response to an authentication prompt generated based on the first authentication input.

5. The system of claim 1, wherein receiving the second authentication input further comprises receiving a third authentication input in response to an authentication prompt generated based on the first authentication input.

6. The system of claim 5, wherein initiating execution of the transaction comprises initiating execution of the transaction based on the validation of the first authentication input, the second authentication input, and the third authentication input.

7. The system of claim 1, wherein processing the transaction initiation request comprises processing the transaction initiation request based on or more rules.

8. The system of claim 7, wherein the one or more rules comprises at least one of: an entity restriction, a transaction amount restriction, a transaction frequency restriction, or a geographic restriction.

9. The system of claim 1, wherein processing the transaction initiation request comprises processing the transaction initiation request based on or more other transactions.

10. The system of claim 1, wherein receiving the transaction initiation request comprises receiving the transaction initiation request with respect to a first user.

11. The system of claim 10, wherein validating the first authentication input comprises validating the first authentication input with respect to the first user.

12. The system of claim 11, wherein validating the second authentication input comprises validating the second authentication input with respect to a second user.

13. The system of claim 10, wherein validating the first authentication input comprises validating the first authentication input with respect to a second user.

14. A method comprising:
receiving a transaction initiation request;
processing the transaction initiation request to generate a first transaction segment and a second transaction segment;
receiving, in response to an authentication prompt generated based on the first authentication input and via a first device, a first authentication input with respect to the first transaction segment;
validating the second authentication input;
receiving, via a second device, a second authentication input with respect to the second transaction segment;
validating the second authentication input; and
based on a validation of the first authentication input with respect to the first transaction segment and a validation of the second authentication input with respect to the second transaction segment, initiating execution of a transaction corresponding to the transaction initiation request.

15. The method of claim 14, wherein processing the transaction initiation request comprises processing the transaction initiation request based on or more rules.

16. The method of claim 15, wherein the one or more rules comprises at least one of: an entity restriction, a transaction amount restriction, a transaction frequency restriction, or a geographic restriction.

17. The method of claim 14, wherein receiving the transaction initiation request comprises receiving the transaction initiation request with respect to a first user.

18. The method of claim 17, wherein validating the first authentication input comprises validating the first authentication input with respect to a second user.

19. A non-transitory computer readable medium having instructions stored thereon that, when executed by a processing device, cause the processing device to perform operations comprising:
receiving a transaction initiation request with respect to a first user;
processing the transaction initiation request to generate a first transaction segment and a second transaction segment;
receiving, via a first device, a first authentication input with respect to the first transaction segment;
validating the first authentication input with respect to a second user;
receiving, via a second device, a second authentication input with respect to the second transaction segment;
validating the second authentication input; and
based on a validation of the first authentication input with respect to the first transaction segment and a validation of the second authentication input with respect to the second transaction segment, initiating execution of a transaction corresponding to the transaction initiation request.

20. The non-transitory computer readable medium of claim 19, wherein processing the transaction initiation request comprises processing the transaction initiation request based on or more rules comprising at least one of: an entity restriction, a transaction amount restriction, a transaction frequency restriction, or a geographic restriction.
